(19) United States
(12) Patent Application Publication
(10) Pub. No.: US 2018/0345626 A1
(43) Pub. Date: Dec. 6, 2018

(54) COMPOSITE CUSHIONING MATERIAL

(71) Applicant: KITAGAWA INDUSTRIES CO., LTD., Aichi (JP)

(72) Inventor: Shinya WASHINO, Kasugai-shi (JP)

(73) Assignee: KITAGAWA INDUSTRIES CO., LTD., Aichi (JP)

(21) Appl. No.: 15/992,253

(22) Filed: May 30, 2018

(30) Foreign Application Priority Data
May 31, 2017 (JP) 2017-107837

(51) Int. Cl. B32B 7/12; B32B 5/18

(52) U.S. Cl. CPC B32B 7/12; B32B 5/18; B32B 2305/022; B32B 2307/51; B32B 2250/22

(57) ABSTRACT

PROBLEM: To provide a cushioning material excelling in impact absorption with respect to a movable member and a receiving member.

SOLUTION: The present invention provides a composite cushioning material installed on a receiving member to receive a movable member, the composite cushioning material including a high damping elastomer having a JIS-A hardness of 20 or greater and a loss factor of 2.0 or greater, and a low hardness elastomer disposed between the high damping elastomer and the receiving member and having an ASKER-FP hardness of 80 or less; and a ratio of thicknesses between the high damping elastomer and the low hardness elastomer being in a range from 4:1 to 1:4.

### CROSS-REFERENCE TG RELATED APPLICATIONS

This application claims the benefit of Japanese Patent Application No. 2017-107337 filed May 31, 2017 in the Japan Patent Office, and the entire disclosure of Japanese Patent Application No. 2017-107837 is incorporated herein by reference.

### BACKGROUND

The present invention relates to a composite cushioning material.

Known cushioning materials used in precision devices, electronic devices, and the like include, for example, materials for which, a softening agent is mixed into a styrene-based elastomer or other such thermoplastic polymer organic material to reduce hardness, and a hydrogenated petroleum resin is added for improved vibration damping property, thermal resistance and weather resistance.

### CITATION LIST

### Patent Literature

Patent Document 1: Japanese Unexamined Patent Application Publication No. 2001-19861A

Parent Document 2: Japanese Unexamined Patent Application Publication No. 2001-19853A

### SUMMARY

For example, with opening and closing doors of the above-mentioned devices, push, buttons for industrial use, and the like, in a case where a side to which impact is applied is considered to be a movable member, and a side in which impact is received is considered to be a receiving member, and a cushioning material is disposed at the receiving member side, the magnitudes of impact received from the cushioning material by each of the movable member and the receiving member are not equivalent, and differ depending on the performance of the cushioning material. More specifically, in a case where cushioning material with relatively low hardness is used, the impact absorption with respect to the receiving member is high, but margin for improvement in the impact absorption with respect to the movable member remains. Conversely, in a case where a cushioning material with a high damping property is used, the impact absorption with respect to the movable member is high, but the impact absorption with respect to the receiving member is insufficient. Namely, with a cushioning material made from a single material, it has been difficult to achieve excellent impact absorption with respect to both the movable member and the receiving member.

Also, in some cases, particularly high impact absorption is required of either the receiving member or the movable member, and a cushioning material having such performance is desired.

The present invention was completed based on conditions like those described above, and an object of the present invention is to provide a cushioning material excelling in impact absorption with respect to a movable member and a receiving member.

The present invention is a composite cushioning material installed on a receiving member to receive a movable member, the composite cushioning material including: a high damping elastomer having a JIS-A hardness of 20 or greater and a loss factor of 2.0 or greater, and a low hardness elastomer disposed between the high damping elastomer and the receiving member and having an ASKER-FP hardness of 80 or less, and a ratio of thicknesses between the high damping elastomer and the low hardness elastomer being in a range from 4:1 to 1:4.

According to the above-mentioned configuration, excellent impact, absorption with respect, to the movable member is obtained by the high damping elastomer, and excellent impact absorption with respect to the receiving member is obtained by the low hardness elastomer disposed further at the receiving member side than the high damping elastomer. This type of excellent impact absorption with respect to both a movable member and a receiving member can be obtained by adopting a configuration provided with a plurality of types of elastomers, and can be significantly improved in comparison to known technology that configures a cushioning material with a single member. Namely, rather than obtaining ail characteristics with a cushioning material configured from a single member, a cushioning material capable of achieving the necessary impact absorption through a plurality of layers can be obtained.

Note that the thickness of the elastomer of the present invention is defined as the thickness of the elastomer layer along the direction in which impact is applied.

In addition, the present invention is a composite cushioning material installed on a receiving member to receive a movable member, the composite cushioning material including: a high damping elastomer having a JIS-A hardness of 20 or greater and a loss factor of 2.0 or greater, and a low hardness elastomer disposed between the high damping elastomer and the receiving member and having an ASKER-FP hardness of 95 or less, and a ratio of thicknesses between the high damping elastomer and the low hardness elastomer being 4:1.

To realize high impact absorption with respect to a movable member, a cushioning material mads from a high damping elastomer has been, used in the related art. According to the above-mentioned configuration of the present invention, a low hardness elastomer is provided at the above-mentioned ratio between the high damping elastomer and the receiving member. Thus, even when configured with an equivalent thickness as that of a cushioning material made from a single material, the composite cushioning material of the present invention can further increase the impact absorption with respect to the movable member.

Furthermore, the present invention is a composite cushioning material installed on a receiving member to receive a movable member, the composite cushioning material including: a high damping elastomer having a JIS-A hardness of 20 or greater and a loss factor of 0.95 or greater, and a low hardness elastomer disposed between the high damping elastomer and the receiving member and having an ASKER-FP hardness of 95 or less, and a ratio of thicknesses between the high damping elastomer and the low hardness elastomer being in a range from 3:2 to 1:4.

To realize high impact absorption with respect to a receiving member, a cushioning material made from a low hardness elastomer has been used in the related art. According to the above-mentioned configuration of the present invention, a high damping elastomer is provided at the above-mentioned ratio further to the movable member side than the low hardness elastomer. Thus, even when configured with an equivalent thickness as that of a cushioning material made from a single material, the composite cushioning material of the present invention can further increase the impact absorption with respect to the receiving member.

According to the present invention, a cushioning material excelling in impact absorption with respect to a movable member and a receiving member can be obtained.

### BRIEF DESCRIPTION OF THE DRAWINGS

The invention will be described with reference to the accompanying drawings, wherein like numbers reference like elements.

FIG. 1 is a partial enlarged cross-sectional view of a condition in which a composite cushioning material of one embodiment is installed on a measuring bench.

FIG. 2 is a schematic view of a measuring device used in the evaluation of the impact absorption.

### DESCRIPTION OF EMBODIMENTS

Embodiments of the present invention will be described in detail below. The present invention is based on a discovery that a composite cushioning material including a high damping elastomer having a JIS-A hardness of 20 or greater and a loss factor of 2.0 or greater, and a low hardness elastomer disposed between the high damping elastomer and the receiving member and having an ASKER-FP hardness of 80 or less exhibits more excellent impact absorption with respect to both a movable member and a receiving member in comparison to a known cushioning material of the same thickness as that of the composite cushioning material.

Examples of the high damping elastomers include elastomers containing a thermoplastic polymer organic material, a softening agent, and a hydrogenated petroleum resin. Of these, as the thermoplastic polymer organic material, hydrogenated styrene block copolymers obtained by hydrogenating a block copolymer containing at least one type of polymer block having polystyrene as a main component and at least one type of polymer block having an unsaturated chain hydrocarbon as a main component are preferable. More specifically, examples include styrene-based elastomers such as styrene-ethylene-propylene-styrene based elastomers, and styrene-ethylene-butadiene-styrene based elastomers.

Examples of the softening agent include mineral-, vegetable oil-, and synthetic-based softening agents. Of these, use of one softening agent or a mixture of two or more softening agents selected from paraffin-, naphthene-, and aromatic-based process oils, which are mineral-based softening agents, is preferable.

Furthermore, a high damping elastomer having the desired hardness can be obtained by adding a hydrogenated petroleum resin to these components and varying the mixing ratio thereof.

Note that in place of the hydrogenated petroleum resin, one or more types of resins selected from hydrogenated rosin resins, hydrogenated terpene resins, aromatic resins, and coumarone resins can also be used.

Moreover, the loss factor of the present invention is measured by the full width at half maximum method, which is a resonance method for measuring near the resonance frequency. Measurements using the full width at half maximum method can be performed using, for example, a vibration tester from Emic Corporation. Note that a loss factor measured by the full width at half maximum method correlates with a loss factor obtained through dynamic viscoelasticity measurements, and exhibits the same tendencies.

Examples of low hardness elastomers include elastomers containing a thermoplastic polymer organic material and a softening agent. As the thermoplastic polymer organic material, for example, the same hydrogenated styrene block copolymers as those of the high damping elastomer described above (namely, styrene-ethylene-propylene-styrene based elastomers, styrene-ethylene-butadiene-styrene based elastomers, etc.) can be used. Moreover, olefin-based, ester-based, amide-based, urethane-based, and other various types of thermoplastic elastomers, modified products thereof modified through hydrogenation and the like, other thermoplastic resins, and mixtures of these rubber modified products can be used.

Examples of the softening agent include mineral oil-, vegetable oil-, and synthetic-based softening agents. Examples of the mineral oil based softening agents include paraffin-, naphthene-, and aromatic-based process oils, and one or a mixture of two or more types selected from these can be used.

A low hardness elastomer having the desired hardness can be obtained by varying the mixing ratio between these thermoplastic polymer organic materials and softening agents.

Note that the JIS-A hardness and loss factor of the high damping elastomer, and the ASKER-FP hardness of the low hardness elastomer in the present invention can be set to desired values by changing the mixing ratio of the above-mentioned materials.

A covering film such as a PET film may be affixed to each surface of the high damping elastomer and the low hardness elastomer. In a case where this type of covering film is provided, bleeding of the high damping elastomer and low hardness elastomer can be suppressed. Furthermore, the covering film leads to improved workability because tackiness when handling these elastomers is improved.

In addition, the high damping elastomer and the low hardness elastomer can be bonded together using, for example, a tacky adhesive or an adhesive. Moreover, the composite cushioning material in which these elastomers are laminated and integrated can be fixed to the receiving member by a tacky adhesive or an adhesive, for example.

### EXAMPLES

As examples of the present invention, the two types of high damping elastomers shown in Table 1 were prepared by varying the mixing ratios between a styrene-ethylene-propylene-styrene elastomer, a paraffin-based process oil, and a hydrogenated petroleum resin.

As examples, the two types of low hardness elastomers shown in Table 1 were prepared by varying the mixing ratios between a styrene-ethylene-propylene-styrene elastomer and a paraffin-based process oil.

TABLE 1

| | JIS-A | ASKER-FP | Loss |
|---|---|---|---|
| | hardness | hardness | factor |
| High damping | 20 | 100 | 2.05 |
| elastomer A | | | |
| High damping | 37 | 100 | 0.96 |
| elastomer B | | | |
| Low hardness | 0 | 80 | 0.26 |
| elastomer A | | | |
| Low hardness | 7 | 95 | 0.22 |
| elastomer B | | | |

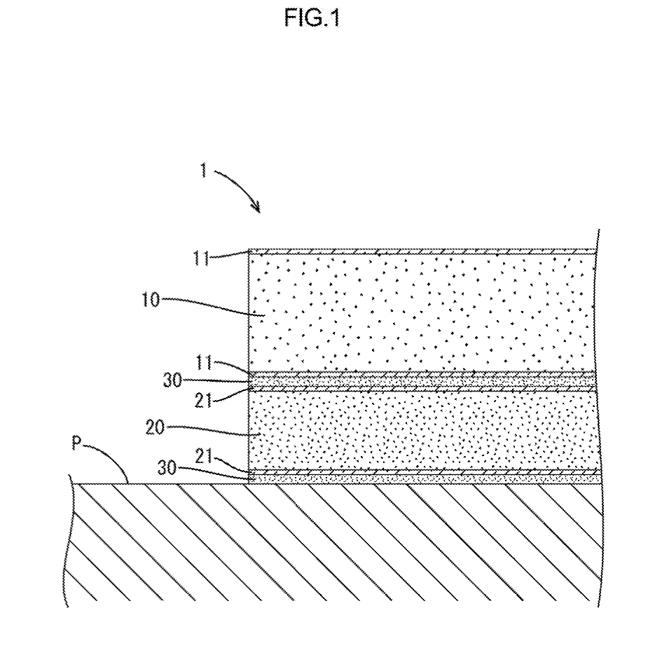

Each of these materials was extruded at a prescribed thickness by an extrusion molding machine to form a sheet shape, and a PET film having a thickness of 0.63 μm was affixed to both the front and back surfaces of each elastomer. Furthermore, the various sheets of the thicknesses shown in Table 2 were combined and bonded together through 120 μm of acrylic tacky adhesive (see FIG. 1), and 14 types of sheets having a thickness of approximately 5 mm were prepared as examples (Examples 1 to 14).

Also, as comparative examples, approximately 5 mm thick sheets of a single layer (Comparative Examples 1 to 4), and samples obtained by combining and bonding the above-mentioned elastomer sheets together at the thicknesses shown in Table 2 (Comparative Examples 5 and 6) were prepared. Samples (Comparative Examples 7 and 8) were also prepared in which the top and bottom layering of the high damping elastomer A and the low hardness elastomer A of Examples 1 and 2 was switched so that the low hardness elastomer A was positioned at the movable side, and the high damping elastomer A was positioned at the receiving side.

Note that the tolerance of the thickness of each elastomer layer in the present examples and comparative examples was ±0.3 mm.

### Evaluation of Impact Absorption

Samples having a size of 5×10 (mm) were cut from the prepared sheet shaped composite cushioning materials, and were affixed to a measuring bench via 120 μm of acrylic tacky adhesive (see FIG. 1).

FIG. 1 illustrates a state in which a sample 1 of a composite cushioning material of one example is affixed to a measuring bench P. The sample 1 of the composite cushioning material was affixed, oriented with a low hardness elastomer 20 disposed at the measuring bench P side. This was done to draw out the maximum effectiveness of elastomers 10 and 20 by arranging the high damping elastomer 10 having excellent impact absorption with respect to the movable member at the movable side (top layer), and arranging the low hardness elastomer 20 having excellent impact absorption with respect to the receiving member at the receiving side (bottom layer). In addition, by arranging the high damping elastomer 10 at the movable side, effectiveness with respect to wear resistance can also be anticipated. Note that the reference numerals 11 and 21 in the drawing represent respective PET films affixed to the surfaces of elastomers 10 and 20, and the reference numeral 30 in the drawing represents an acrylic tacky adhesive.

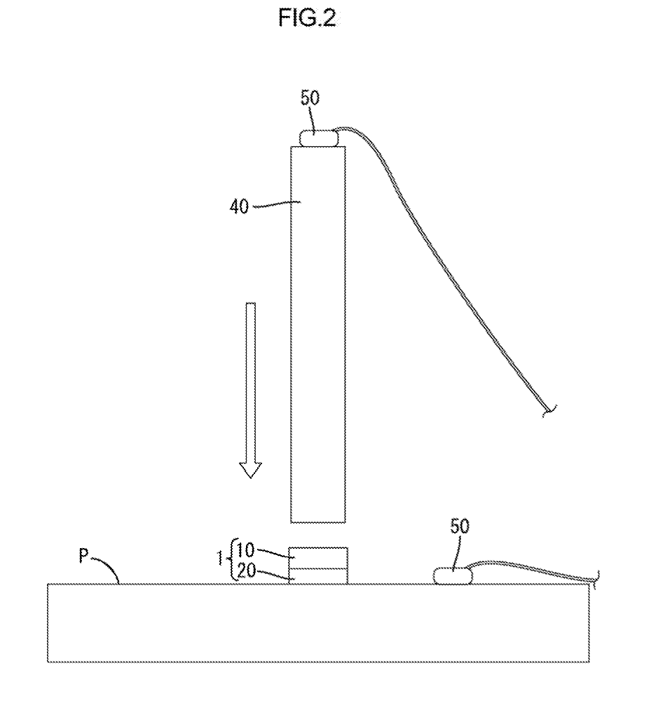

Impact absorption tests were conducted on each of the prepared samples. FIG. 2 is a schematic view of a device used in this test. For a case in which a cylindrical rod 40, made from iron and having a diameter φ of 12 mm and a weight of 270 g, was dropped from a height of 150 mm above the surface of the sample 1, the movement acceleration of the sample 1 was measured using two accelerometers 50, one installed on the cylindrical rod 40 side and one installed on the measuring bench P side. The accelerometer 50 of the cylindrical rod 40 side was installed on the top surface of the cylindrical red 40. Moreover, the accelerometer 50 of the measuring bench P side was installed, at a position separated 20 mm from the sample 1 installed on the measuring bench P. The acceleration measured by the accelerometer 50 of the cylindrical rod 40 side indicates the acceleration of the movable member, and the acceleration measured by the accelerometer 50 of the measuring bench P side indicates the acceleration of the receiving member.

The measurement results are shown in Table 2.

TABLE 2

| | | | | | Receiving | |
|---|---|---|---|---|---|---|
| | | | | Movable side | side | Total |
| | | | Total | acceleration | acceleration | acceleration |
| Sample | Type | Thickness | thickness | [G] | [G] | [G] |
| Comparative | High | 5 mm | 5 mm | 20.58 | 36.7 | 57.28 |
| Example 1 | damping A | | | | | |
| Comparative | High | 5 mm | 5 mm | 26.99 | 59.73 | 86.72 |
| Example 2 | damping B | | | | | |
| Comparative | Low | 5 mm | 5 mm | 23.63 | 26.54 | 54.17 |
| Example 3 | hardness A | | | | | |
| Comparative | Low | 5 mm | 5 mm | 26.39 | 18.97 | 45.36 |
| Example 4 | hardness B | | | | | |
| Example 1 | High | 4 mm | 5 mm | 18.88 | 19.78 | 38.66 |
| | damping A | | | | | |
| | Low | 1 mm | | | | |
| | hardness A | | | | | |
| Example 2 | High | 3 mm | 5 mm | 23.17 | 14.27 | 37.44 |
| | damping A | | | | | |
| | Low | 2 mm | | | | |
| | hardness A | | | | | |
| Example 3 | High | 2 mm | 5 mm | 24.61 | 18.02 | 42.62 |
| | damping A | | | | | |
| | Low | 3 mm | | | | |
| | hardness A | | | | | |
| Example 4 | High | 1 mm | 5 mm | 24.95 | 19.39 | 44.34 |
| | damping A | | | | | |
| | Low | 4 mm | | | | |
| | hardness A | | | | | |
| Example 5 | High | 4 mm | 5 mm | 20.29 | 30.91 | 51.19 |
| | damping A | | | | | |
| | Low | 1 mm | | | | |
| | hardness B | | | | | |
| Example 6 | High | 3 mm | 5 mm | 24.24 | 17.11 | 41.36 |
| | damping A | | | | | |
| | Low | 2 mm | | | | |
| | hardness B | | | | | |
| Example 7 | High | 2 mm | 5 mm | 25.12 | 16.83 | 41.94 |
| | damping A | | | | | |
| | Low | 3 mm | | | | |
| | hardness B | | | | | |
| Example 8 | High | 1 mm | 5 mm | 25.87 | 18.04 | 43.91 |
| | damping A | | | | | |
| | Low | 4 mm | | | | |
| | hardness B | | | | | |
| Example 9 | High | 3 mm | 5 mm | 29.77 | 16.48 | 46.26 |
| | damping B | | | | | |
| | Low | 2 mm | | | | |
| | hardness A | | | | | |
| Example 10 | High | 2 mm | 5 mm | 28.72 | 17.17 | 45.83 |
| | damping B | | | | | |
| | Low | 3 mm | | | | |
| | hardness A | | | | | |
| Example 11 | High | 1 mm | 5 mm | 27.50 | 19.37 | 47.48 |
| | damping B | | | | | |
| | Low | 4 mm | | | | |
| | hardness A | | | | | |
| Example 12 | High | 3 mm | 5 mm | 26.97 | 18.53 | 45.43 |
| | damping B | | | | | |
| | Low | 2 mm | | | | |
| | hardness B | | | | | |
| Example 13 | High | 2 mm | 5 mm | 27.91 | 17.39 | 45.29 |
| | damping B | | | | | |
| | Low | 3 mm | | | | |
| | hardness B | | | | | |
| Example 14 | High | 1 mm | 5 mm | 26.59 | 19.77 | 46.36 |
| | damping B | | | | | |
| | Low | 4 mm | | | | |
| | hardness B | | | | | |
| Comparative | High | 4 mm | 5 mm | 26.63 | 35.36 | 61.99 |
| Example 5 | damping B | | | | | |
| | Low | 1 mm | | | | |
| | hardness A | | | | | |
| Comparative | High | 4 mm | 5 mm | 25.22 | 32.08 | 57.30 |
| Example 6 | damping B | | | | | |
| | Low | 1 mm | | | | |
| | hardness B | | | | | |
| Comparative | Low | 4 mm | 5 mm | 25.69 | 20.63 | 46.32 |
| Example 7 | hardness A | | | | | |
| | High | 1 mm | | | | |
| | damping A | | | | | |
| Comparative | Low | 3 mm | 5 mm | 23.81 | 18.27 | 42.08 |
| Example 8 | hardness A | | | | | |
| | High | 2 mm | | | | |
| | damping A | | | | | |

A smaller numeric value for the acceleration (G) indicates better impact absorption.

As shown in Table 2, with each of Examples 1 to 4 in which a high damping elastomer A having a JIS-A hardness of 20 or greater and a loss factor of 2.0 or greater and a low hardness elastomer A having an ASKER-FP hardness of 80 or less were combined at a thickness ratio in a range from 4:1 to 1:4, smaller values were exhibited for the total value (total acceleration) of the movable side acceleration and the receiving side acceleration compared to the known single layer cushioning materials presented in Comparative Examples 1 to 4. Even when only the movable side acceleration is compared, values which are generally smaller than those of the known samples are presented, and Example 1 in particular exhibits a value which is smaller than the value of Comparative Example 1, which is a small value in the related art. Furthermore, even when only the receiving side acceleration is compared, Examples 2 and 3 exhibit values which are smaller than that of Comparative Example 4, which exhibits the smallest value of the known samples, and even Examples 1 and 4 exhibit values which are not inferior to the smallest value in the related art.

In other words, it can be said that in comparison to the cushioning materials of Comparative Examples 1 to 4, which are known single layer materials, the composite cushioning materials of the combinations of Examples 1 to 4 excel in individual, impact absorption with respect to the movable member and the receiving member, and excel in impact absorption with a good balance with respect to both.

With each of Examples 1 and 5 in which the high damping elastomer A having a JIS-A hardness of 20 or greater and a loss factor of 2.0 or greater and the low hardness elastomers A and B having an ASKER-FP hardness of 95 or less were combined so that the thickness ratio was 4:1, smaller values were exhibited for movable side acceleration when compared to Comparative Example 1, which is particularly excellent from amongst the known single layer cushioning materials presented in Comparative Examples 1 to 4.

In other words, it can be said that the composite cushioning materials of the combinations of Examples 1 and 5 particularly excel in impact absorption with respect to the movable member.

With each of Examples 2 to 4 and Examples 6 to 14 in which the high damping elastomer A having a JIS-A hardness of 20 or greater and a loss factor of 0.95 or greater and the low hardness elastomers A and B having an ASKER-FP hardness of 95 or less were combined so that the thickness ratio was from 3:2 to 1:4, smaller values or values which were not inferior were exhibited for the receiving side acceleration in comparison to Comparative Example 4, which is particularly excellent from, amongst the known single layer cushioning materials presented in Comparative Examples 1 to 4.

Moreover, even Example 1, in which the high damping elastomer A and the low hardness elastomer A were combined so that the thickness ratio became 4:1, exhibited a value for the receiving side acceleration which likewise was not inferior to that of Comparative Example 4.

In other words, it can be said that the composite cushioning materials of the combinations of Examples 1 to 4 and Examples 6 to 14 particularly excel in impact absorption with respect to the receiving member.

Note that with the samples of Comparative Examples 5 and 6, which do not fall within the any of the scopes of the present invention, the acceleration of the receiving side was particularly large, and therefore the total acceleration values were also large.

Also, with Comparative Examples 7 and 8 in which the types of the top and bottom layers of the high damping elastomer A and the low hardness elastomer A of Examples 1 and 2 were switched, the values for both the movable side acceleration and the receiving side acceleration were not inferior to the values of the other samples, but both values were larger compared to the values of Examples 1 and 2. Note that even from the viewpoint of durability, it can be said that arranging the low hardness elastomer at the receiving member side is desirable.

From the above results, it was confirmed that according to the composite cushioning material of the above-mentioned examples that embodied the present invention, a cushioning material having excellent impact absorption with respect to a movable member and a receiving member, and a cushioning material having impact absorption superior to that of known cushioning materials with respect to one of the movable member side or the receiving member side can be obtained.

### Other Examples

The present invention is not limited by the preceding recitations and/or the examples described using the drawings, and for example, the following types of examples should be construed to be included in the scope of the technology disclosed in the present invention.

(1) In the above-mentioned examples, the ratio of the thicknesses between the high damping elastomer and the low hardness elastomer was expressed as an integer ratio, but a tolerance range is also actually included. The tolerance range includes approximately ±30% of each thickness (for example, ±0.3 mm with respect to 1 mm).

(2) The above-mentioned examples were configured with a PET film affixed to the surfaces of each elastomer, but a portion or ail of the PET film may be omitted.

(3) With respect to each of the above-mentioned examples, an example which uses a styrene-based elastomer was presented, but the type of elastomer is not limited to the above-mentioned examples.

(4) In the above-mentioned examples, a configuration was presented in which the high damping elastomer and the low hardness elastomer were integrally laminated with an acrylic tacky adhesive, but any aspect may be used as long as the configuration is such that the elastomers can be integrally laminated. For example, a configuration may be used which retains a state in which each elastomer is integrally formed using tackiness without interposing PEF films and a tacky adhesive, or in which another member is used to integrally laminate the elastomers.

(5) A configuration containing another layer other than the above-mentioned layers is also included in the technical scope of the present invention.

What is claimed is:

1. A composite cushioning material installed on a receiving member to receive a movable member, the composite cushioning material comprising:
a high damping elastomer having a JTS-A hardness of 20 or greater and a loss factor of 2.0 or greater; and
a low hardness elastomer disposed between the high damping elastomer and the receiving member and having an ASKER-FP hardness of 80 or less;
a ratio of thicknesses between the high damping elastomer and the low hardness elastomer being in a range from. 4:1 to 1:4.

2. A composite cushioning material installed on a receiving member to receive a movable member, the composite cushioning material comprising:
a high damping elastomer having a JIS-A hardness of 20 or greater and a loss factor of 2.0 or greater; and
a low hardness elastomer disposed between the high damping elastomer and the receiving member and having an ASKER-FP hardness of 95 or less;
a ratio of thicknesses between the high damping elastomer and the low hardness elastomer being 4:1.

3. A composite cushioning material installed on a receiving member to receive a movable member, the composite cushioning material comprising:
a high damping elastomer having a JTS-A hardness of 20 or greater and a loss factor of 0.95 or greater; and
a low hardness elastomer disposed between the high damping elastomer and the receiving member and having an ASKER-FP hardness of 95 or less;
a ratio of thicknesses between the high damping elastomer and the low hardness elastomer being in a range from 3:2 to 1:4.
